(19) United States
(12) Patent Application Publication
(10) Pub. No.: US 2007/0217645 A1
(43) Pub. Date: Sep. 20, 2007

(54) Speaker

(75) Inventor: Takeshige Ishihara, Nagano (JP)

Correspondence Address: FOLEY AND LARDNER LLP;SUITE 500, 3000 K STREET NW, WASHINGTON, DC, 20007, US

(73) Assignee: Minebea Co., Ltd.

(21) Appl. No.: 11/717,626

(22) Filed: Mar. 14, 2007

(30) Foreign Application Priority Data
Mar. 15, 2006 (JP) 2006-071039

(51) Int. Cl. H04R 9/06

(52) U.S. Cl. 381/396

(57) ABSTRACT

A speaker is provided and includes a diaphragm which is composed of a primary planar disc and a secondary planar disc which has a smaller diameter than the primary planar disc. The primary and secondary planar discs are concentrically put together by means of adhesive, which makes the outer rim of the primary planar disc clear of the secondary planar disc thus forming a surround thereat. The ratio of the diameter of the secondary planar disc relative to the effective diameter of the primary planar disc is optimally determined, whereby the resonance frequency of the diaphragm can be lowered, and the input power threshold limit value keeping off generation of an abnormal sound can be raised. Accordingly, a low profile speaker with an excellent performance can be produced.

The present application claims foreign priority based on Japanese Patent Application No. JP2006-71039 filed on Mar. 15 of 2006, the entire disclosure of which is incorporated herein by reference.

### BACKGROUND OF THE INVENTION

1. Field of the Invention

The present invention relates to a speaker, and particularly to a speaker for use in various audio equipment.

2. Description of the Related Art

Since compact electronic devices, such as mobile telephones, allow a limited space for mounting components, a speaker incorporated therein must have minimal dimensions and profiles, which often forces the sound quality to become a lower priority. However, with the spread of digital audio players, there is an increasing demand for a high performance even for a small speaker, so various speakers are disclosed to answer this demand (refer to, for example, Japanese Patent Application Laid-Open No. H11-27789).

Such a micro speaker usually includes a diaphragm made of a polyethylene terephthalate (PET) film, or similar material film. This kind of film is easily transformed by applying pressure or heat, and therefore can be formed into a desired configuration by pressing and hot forming. A diaphragm, when formed into a cone or dome structure by pressing and hot forming a film, is caused to define some height according to the structure formed, wherein the larger the height is, the harder it is to achieve a low profile speaker.

To cope with the difficulty described above, it is proposed to make a diaphragm into a planar structure rather than a cone or dome structure. The diaphragm formed into a planar structure, however, is poor in rigidity and so easily subjected to deformation. Also, this planar structure may possibly cause a diaphragm breakup mode when its thickness is reduced in order to lower the lowest resonance frequency, which aggravates the deformation.

### SUMMARY OF THE INVENTION

It is an object of the present invention to provide a speaker which can be reduced in profile without suffering degradation of performance, such as reproduction frequency range and sound quality.

According to an aspect of the present invention, there is provided a speaker which includes: a magnetic circuit including a magnet, a pole piece disposed at the top of the magnet, and a yoke disposed at the bottom of the magnet; a frame disposed at the outer circumference of the yoke; a diaphragm disposed above the top of the magnetic circuit; and a voice coil attached to the diaphragm and suspendedly disposed outside the pole piece with a clearance gap provided therefrom so to be freely movable to and fro. In the speaker described above, the diaphragm includes a primary planar disc which has its outer circumference connected to the frame, and a secondary planar disc which has a smaller diameter than the primary planar disc and which is disposed at either the top or bottom of the primary planar disc thereby forming a surround at the outer rim of the primary planar disc.

In the aspect of the present invention, the ratio of the diameter of the secondary planar disc to the effective diameter of the primary planar disc (this ratio is hereinafter referred to as “disc diameter ratio” as appropriate) may range from 95.0% to 99.0%. The disc diameter ratio may be set so that the diaphragm has a lowest resonance frequency (hereinafter referred to simply as “resonance frequency”) of 1,400 Hz or lower, and also so that the threshold limit value of an input power to apply a sinusoidal voltage to the voice coil without generating an abnormal sound is 0.3 W or higher.

In the aspect of the present invention, the diaphragm may further include an adhesive layer disposed between the primary and secondary planar discs, and the thickness of the primary planar disc is larger than the aggregate thickness of the secondary planar disc and the adhesive layer.

In the aspect of the present invention, the primary and secondary planar discs may be made of a resin film.

In the aspect of the present invention, a cover member which has its outer circumference connected to the frame may be disposed above the diaphragm. The cover member may be formed integrally with the frame.

### BRIEF DESCRIPTION OF THE DRAWINGS

FIG. 1 is a cross sectional view of a speaker according to an exemplary embodiment of the present invention;

FIG. 2 is an enlarged cross sectional view of the speaker of FIG. 1 showing a structure of a diaphragm;

FIG. 3 is a cross sectional view of the speaker of FIG. 1, wherein the diaphragm has a disc diameter ratio (ratio of a diameter of a secondary planar disc to an effective diameter of a primary planar disc) of 95%;

FIG. 4 is a cross sectional view of the speaker of FIG. 1, wherein the diaphragm is composed of a primary planar disc only;

FIG. 5 is a cross sectional view of the speaker of FIG. 1, wherein the diaphragm has a disc diameter ratio of 79%;

FIG. 6 is a cross sectional view of the speaker of FIG. 1, wherein the diaphragm is entirely composed of both a primary planar disc and a secondary planar disc so as to have a disc diameter ratio of 100%;

FIG. 7A is a graph of an output sound pressure level (SPL) response characteristic of the speaker of FIG. 3, wherein a horizontal axis indicates frequency (Hz), and a vertical axis indicates an output SPL (dB), and FIG. 7B is a graph of a total harmonic distortion characteristic of the speaker of FIG. 3, wherein a horizontal axis indicates frequency (Hz), and a vertical axis indicates distortion ratio (%);

FIGS. 8A and 8B respectively are graphs of an output SPL response characteristic and a total harmonic distortion characteristic of the speaker of FIG. 4;

FIGS. 9A and 9B respectively are graphs of an output sound pressure frequency characteristic and a total harmonic distortion characteristic of the speaker of FIG. 5;

FIGS. 10A and 10B respectively are graphs of an output sound pressure frequency characteristic and a total harmonic distortion characteristic of the speaker of FIG. 6

FIG. 11 is a table showing a relation between a resonance frequency fo (Hz) and an input power threshold limit (W) above which an abnormal sound is generated, with respect to each of five different disc diameter ratios (100/98195/87/84%);

FIG. 12 is a graph representing the relation shown by FIG. 11 as a function of the disc diameter ratio ranging from 84% to 100%;

FIG. 13 is a schematic side (partly cross sectional) view of comparison of height dimension between the speaker of FIG. 1 and a conventional speaker; and

FIG. 14 is a cross sectional view of the speaker of FIG. 1, provided with a cover member.

### DETAILED DESCRIPTION OF THE INVENTION

An exemplary embodiment of the present invention will hereinafter be described with reference to the accompanying drawings.

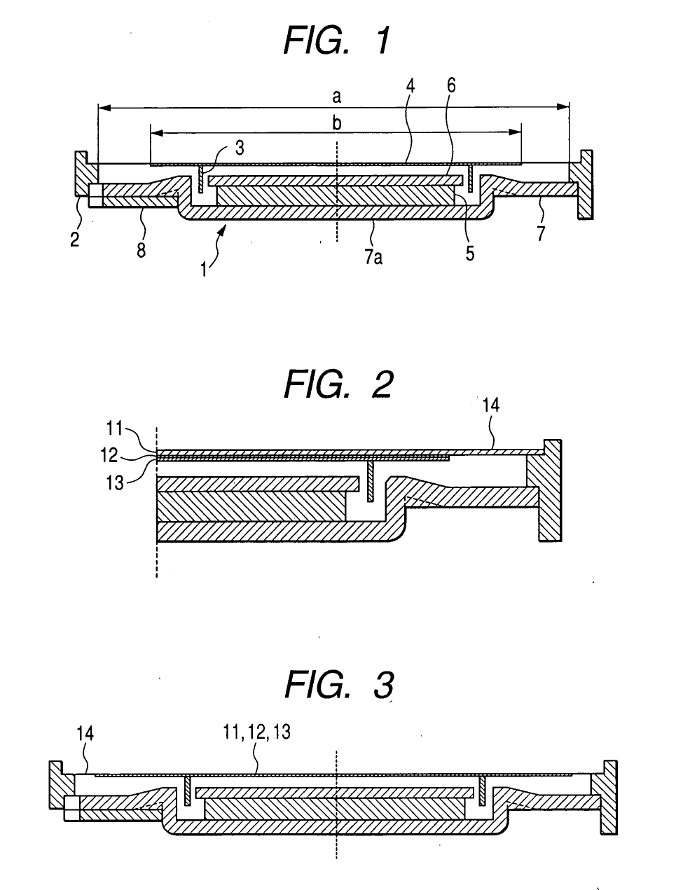

Referring to FIG. 1, a speaker according to an embodiment of the present invention is a micro speaker which, though the invention is not limited to any specific size, may have, for example, a diameter of 10 to 20 mm and a height of 2.0 mm. Such a micro speaker is mounted, for example, in a mobile telephone.

The speaker shown in FIG. 1 includes a magnetic circuit 1, a frame 2, a voice coil 3, and a diaphragm 4. The magnetic circuit 1 includes a magnet 5, a pole piece 6 disposed on the top of the magnet 5, and a yoke 7 disposed on the bottom of the magnet 5. The yoke 7 has a recess portion 7a for accepting the magnet 5 and has its outer circumference connected to the frame 2. The diaphragm 4 is disposed above the magnetic circuit 1. The voice coil 3 has its top end connected to the diaphragm 4 so as to be disposed in a gap area formed outside the pole piece 6, and is adapted to move to and fro (vertically in the figure) together with the diaphragm 4 depending on the direction of current flowing in the voice coil 3.

Referring to FIG. 2 enlargingly showing a relevant portion of the diaphragm 4 of the speaker of FIG. 1, the diaphragm 4 includes a primary planar disc 11 having its outer circumference connected to the frame 2, and a secondary planar disc 13 attached to the primary planar disc 11 via an adhesive layer 12. The primary and secondary planar discs 111 and 13 are circular with the primary planar disc 11 having a larger diameter than the secondary planar disc 13, and are disposed concentric to each other, whereby a surround portion 14 is constituted by the outer circumferential area of the primary planar disc 111 which is clear of the secondary planar disc 13. For example, the primary planar disc 11 may have a thickness of about 50 μm, and the aggregate thickness of the secondary planar disc 13 and the adhesive layer 12 may be about 25 μm. The adhesive layer 12 functions to suppress the abnormal vibration of the diaphragm 4 thereby further reducing distortion as well as to fixedly put together the primary and secondary planar discs 11 and 13. The primary and secondary planar discs 11 and 13 are each a film of, for example, polyimide, polyethylene terephthalate, and polyetherimide. The adhesive layer 12 is formed of an adhesive material, such as heat resistant silicon acrylic resin.

Referring again to FIG. 1, the voice coil 3 is suspendedly supported around the pole piece 6, and has its lead wires (not shown) connected to a terminal plate 8 disposed under the yoke 7. The primary planar disc 11 has a diametral dimension “a” which is clear of the frame 3 and effectively available for vibration, and which is defined as “effective diameter”, and the secondary planar disc 13 has a diameter “b”. The test result by the present inventor shows that the resonance frequency fo of the diaphragm 4 and the input power threshold limit value below which a sinusoidal voltage is applied to the voice coil 3 without generating an abnormal sound are caused to significantly vary with the change of a disc diameter ratio defined by a ratio of the diameter “b” of the secondary planar disc 13 to the effective diameter “a” of the primary planar disc 11.

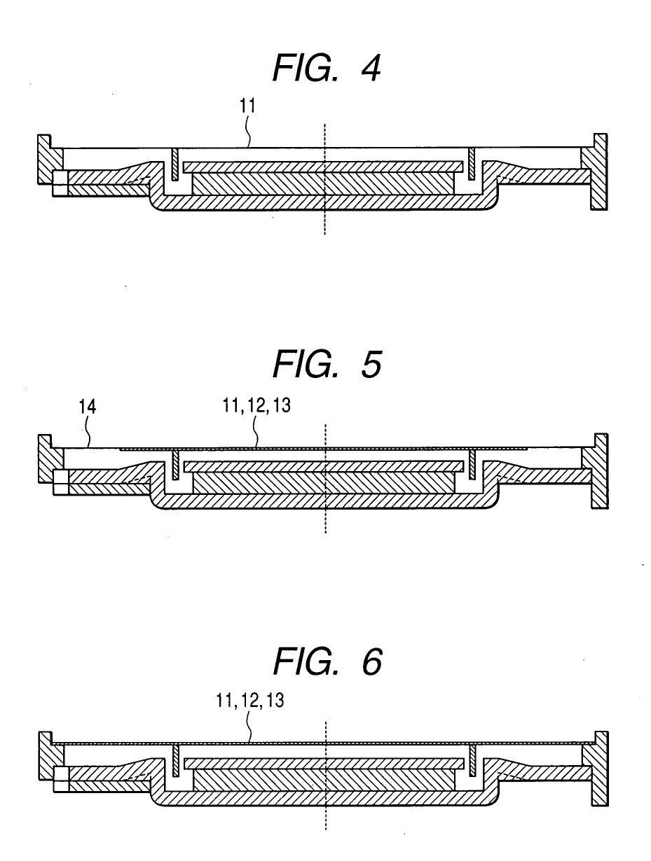

FIGS. 3 to 6 show speakers having respective diaphragms with various diameter ratios. The diaphragm 4 of FIG. 3 is composed of the primary and secondary planar discs 11 and 13 so as to have a diameter ratio of 95%, the diaphragm 4 of FIG. 4 is composed of the primary planar disc 11 only, the diaphragm 4 of FIG. 5 is composed of the primary and secondary planar discs 11 and 13 so as to have a diameter ratio of 79%, and the diaphragm 4 of FIG. 6 has its entire area composed of both the primary and secondary planar discs 11 and 13 thus having a diameter ratio of 100%, wherein the primary and secondary planar discs 11 and 13 in FIGS. 3, 5 and 6 are polyimide films having thicknesses of 50 μm and 25 μm, respectively, and the primary planar disc 11 in FIG. 4 is a polyimide film having a thickness of 100 μm.

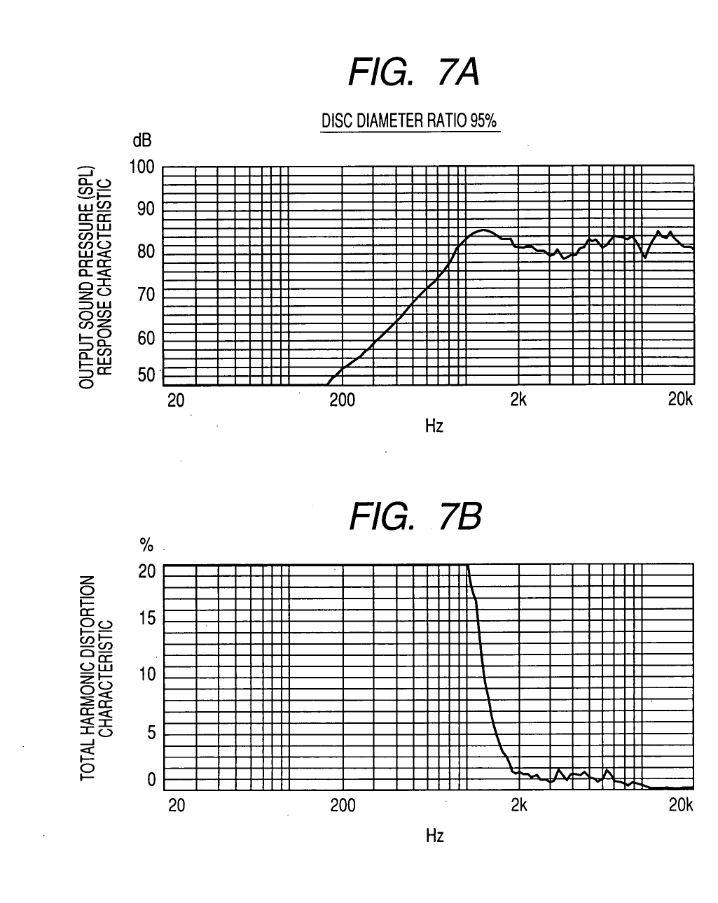

Description will now be made, with reference to FIGS. 7A and 7B, 8A and 8B, 9A and 9B, and 10A and 10B, on the measurement results of the output SPL response characteristic and the total harmonic distortion characteristic of the speakers of FIGS. 3 to 6, respectively. The measurement condition is: input power=0.1 W; and distance from the speaker=10 cm.

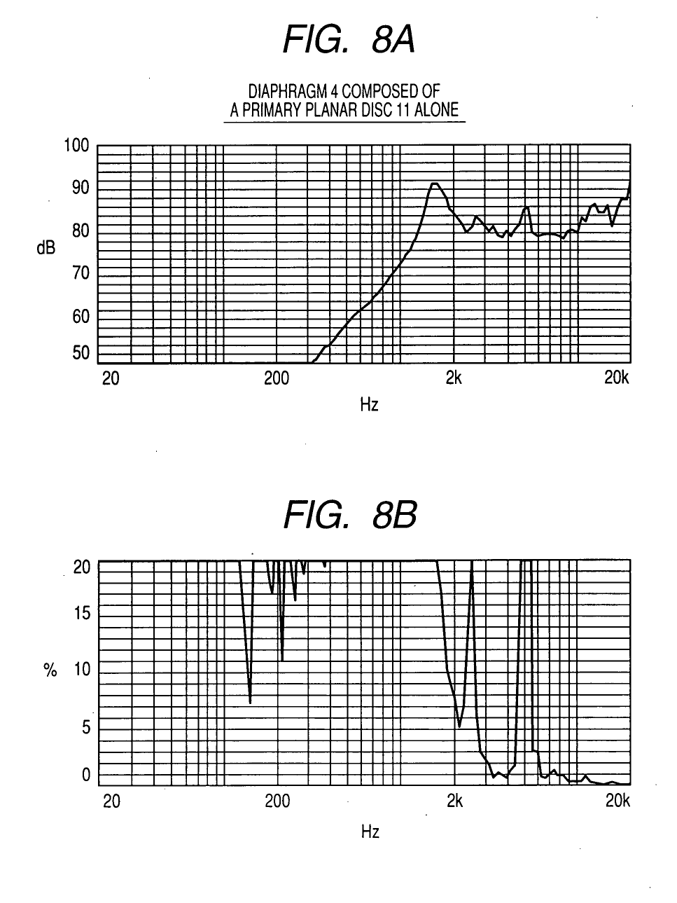

Referring first to FIGS. 8A and 8B, in the speaker of FIG. 4 having the diaphragm 4 composed of the primary planar disc 11 only, a diaphragm breakup mode tends to occur, an abnormal sound is generated, and distortion is considerable in the vicinity of 2.5 kHz and 5.0 kHz (see FIG. 8B).

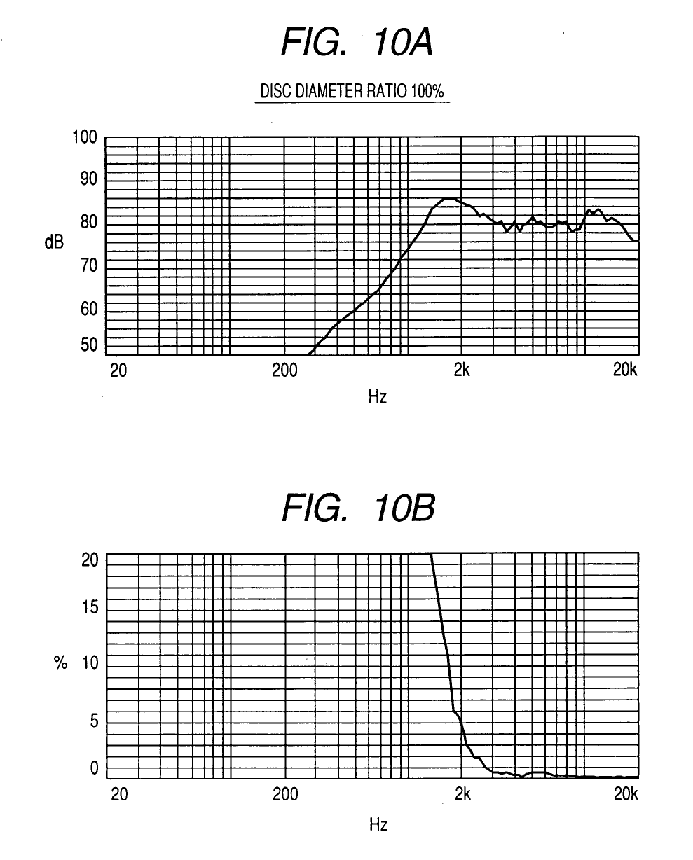

Referring then to FIGS. 10A and 10B, in the speaker of FIG. 6 having the diaphragm 4 composed entirely of both the primary and secondary discs 11 and 13 so as to have a diameter ratio of 100% thus nulling the surround portion 14 (refer to FIG. 2), distortion is hardly caused at 3.0 kHz and higher frequencies (see FIG. 10B), but the resonance frequency fo is found in the vicinity of 1.8 kHz rendering the output SPL of the bass range low.

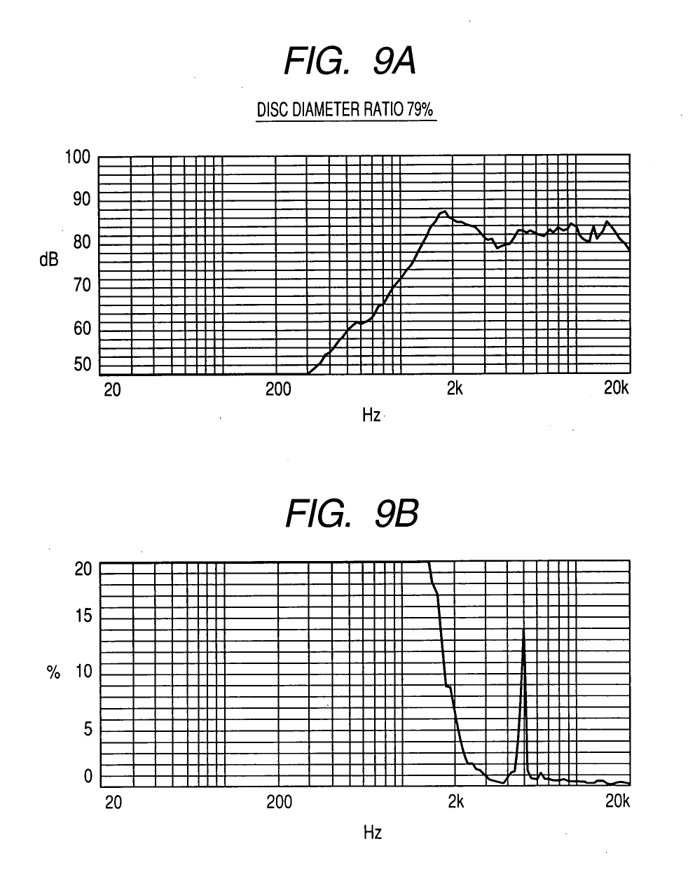

In the speaker of FIG. 5 having the diaphragm 4 with a diameter ratio of 79%, the resonance frequency fo is found also in the vicinity of 1.8 kHz as shown in FIG. 9A, and a significant distortion is seen at a certain frequency range as shown in FIG. 9B, which is caused because the surround portion 14 has a relatively large dimension and therefore becomes structurally loose so as to allow the diaphragm 4 or the voice coil 3 to touch other components, such as a magnetic circuit, thus generating an abnormal sound. However, in case of applying such an input power of 0.1 W as used for the measurement, it does not always happen that the diaphragm 4 having a diameter ratio of 79% makes contact with other components so as to generate an abnormal sound, and this indicates that the diaphragm 4 is caused to vibrate very unsteadily.

On the other hand, in the speaker of FIG. 3 having the diaphragm 4 with a disc diameter ratio of 95%, the resonance frequency fo is found in the vicinity of 1.0 kHz as shown in FIG. 7A rendering the output SPL of the bass range high, and distortion is hardly caused at 2.0 kHz and higher frequencies as shown in FIG. 7B.

Thus, it turns out that the speaker of FIG. 3 having the diaphragm 4 with a disc diameter ratio of 95% provides the widest reproduction frequency band and generates the least distortion.

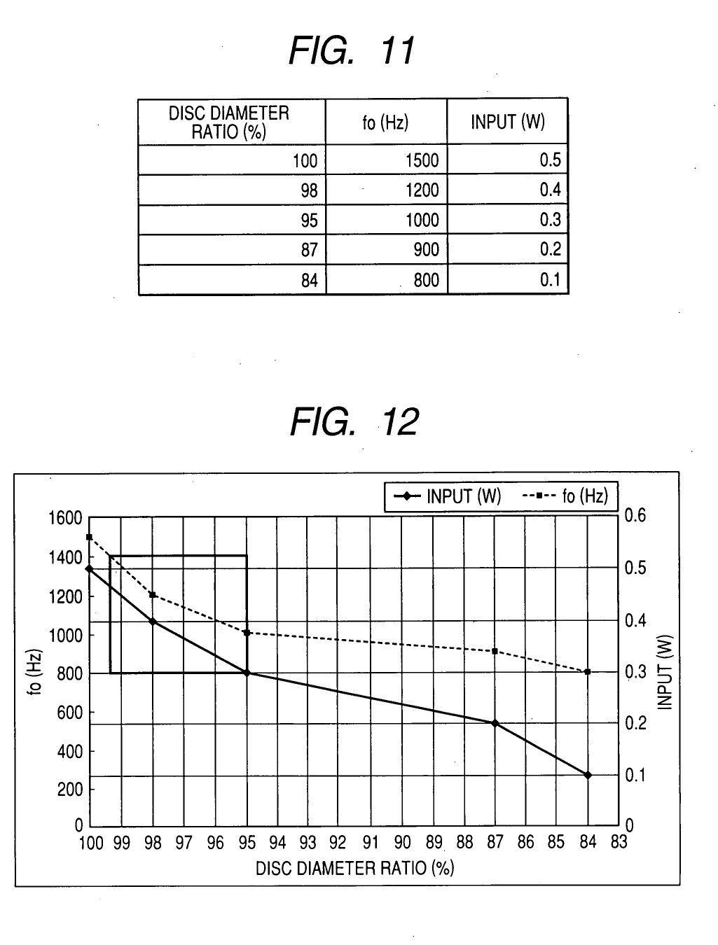

Based on the measurement result described above, the present inventor conducted an experiment with regard to a plurality (specifically, five) of disc diameter ratios in order to find out the resonance frequency fo (Hz) and the input power threshold limit (W) for keeping off generation of an abnormal sound. The measurement result is shown in FIG. 11, where the relation is shown between the respective resonance frequencies fo (Hz) and the input power threshold limit (W) for keeping off an abnormal sound.

FIG. 12 indicates the disc diameter ratio (%) along the horizontal axis, and the resonance frequency fo (Hz) at left and the input power threshold limit (W) at right along the vertical axis with respect to five different disc diameter ratios ranging from 84% up to 100%.

As shown in FIG. 12, the smaller the disc diameter ratio is, the lower the resonance frequency fo and the input power threshold limit are. In this connection, when the disc diameter ratio is smaller than 84% (this case is not indicated in FIG. 12), the surround portion 14 is caused to become loose considerably thereby possibly generating an abnormal sound and also raising the resonance frequency as described with respect to the speaker of FIG. 5 including the diaphragm 4 with a disc diameter ratio of 79% (refer to FIG. 9A).

It is recommended that a micro speaker as described in the present embodiment be provided with a resonance frequency of 1.4 kHz or lower, and operate with an input power threshold limit of 0.3 W or higher, and such a recommendation range is indicated by the heavy-line frame in FIG. 12. The heavy-line frame covers diaphragm body ratios ranging from about 95% to about 99.4%. That is to say, the diaphragm having a disc diameter ratio ranging from 95% to 99.4% can constitute a speaker recommended as above. With reference to the experiment results shown by FIGS. 7A/7B to 12, and also in view of the performance variation due to a manufacturing error, the disc diameter ratio is preferably set to range from 95% to 99%.

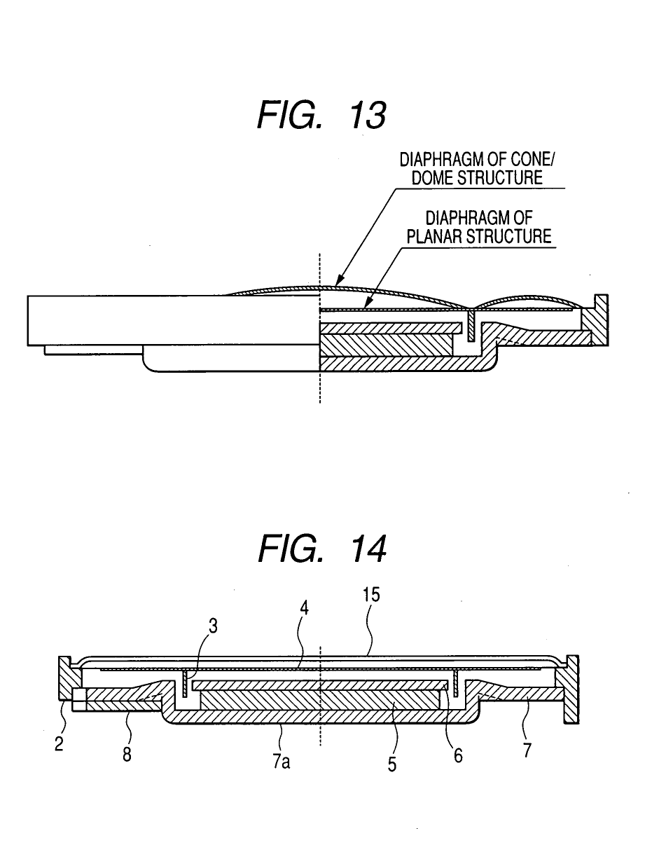

Since the primary and secondary planar discs 11 and 13 constituting the diaphragm 4 are flat, the diaphragm 4 defines a height substantially corresponding to the aggregate thickness of the primary and secondary planar discs 11 and 13, thus the height of the diaphragm 4 can be kept small. Referring to FIG. 13, the diaphragm of a conventional speaker has an arched configuration rather than a planar configuration and so defines a larger height than the diaphragm 4 of the inventive speaker having a flat configuration. Consequently, the speaker according to the above-described embodiment has a smaller height than the conventional speaker.

The diaphragm 4 of the speaker according to the embodiment can be made directly out of a flat film as a base material without using a forming process by application of pressure and heat, thus achieving cost reduction. Since the diaphragm 4 of the speaker according to the embodiment is constituted by a thin film, it may be suggested to provide a cover member 15 as shown in FIG. 14 for protection from external impacts depending on circumstances. The outer circumference of the cover member 15 is connected to the frame 2. Alternatively, the cover member 15 may be formed integrally with the frame 2. A plurality of small holes (not shown) are formed at the cover member 15 so that a sound generated by the diaphragm 4 is not blocked by the cover member 15. With provision of the cover member 15 as described above, the speaker can be employed under the circumstances where the speaker is vulnerable to the external impacts.

Thus, according to the embodiment, since the diaphragm 4 is composed of the primary and secondary planar discs 11 and 13, and also since the disc diameter ratio, that is the ratio of the diameter “b” of the secondary planar disc 13 to the effective diameter “a” of the primary planar disc 11, is set at the optimum value, there is provided a speaker in which the resonance frequency fo is lowered while the input power threshold limit for keeping off generation of an abnormal sound can be raised, and which achieves an excellent performance in reproduction frequency band, sound quality, and the like.

According to the present invention, because of the diaphragm being composed of the primary and secondary planar discs put together, a speaker with an excellent performance in reproduction frequency band, sound quality, and the like can be produced with a low profile structure. Also, since the diaphragm can be produced without using a forming process by application of pressure and heat, cost reduction can be achieved. While the present invention has been particularly shown and described with reference to the exemplary embodiment, it will be understood by those skilled in the art that various changes in form and details may be made therein without departing from the spirit and scope of the invention. For example, the secondary planar disc 13 is disposed at the bottom of the primary planar disc 11 in the embodiment (FIG. 2) described above, but may alternatively be disposed at the top of the primary planar disc 11. Therefore, it is to be understood that the detailed description of the present invention should be taken as illustrative and not limiting, wherein the scope of the present invention should be determined by the claims that follow.

What is claimed is:

1. A speaker comprising:
a magnetic circuit comprising a magnet, a pole piece disposed at a top of the magnet, and a yoke disposed at a bottom of the magnet;
a frame disposed at an outer circumference of the yoke;
a diaphragm disposed above the magnetic circuit, the diaphragm comprising a primary planar disc which has its outer circumference connected to the frame, and a secondary planar disc which has a smaller diameter than the primary planar disc and which is disposed at one of a top and a bottom of the primary planar disc thereby forming a surround at an outer rim of the primary planar disc; and
a voice coil attached to the diaphragm and suspendedly disposed outside the pole piece with a clearance gap provided therefrom so to be freely movable to and fro.

2. A speaker according to claim 1, wherein a disc diameter ratio defined by a ratio of a diameter of the secondary planar disc relative to an effective diameter of the primary planar disc ranges from 95.0% to 99.0%.

3. A speaker according to claim 2, wherein the disc diameter ratio is set so that the diaphragm has a lowest resonance frequency of 1,400 Hz or lower.

4. A speaker according to claim 2, wherein the disc diameter ratio is set so that a threshold limit value of an input power to apply a sinusoidal voltage to the voice coil without generating an abnormal sound is 0.3 W or higher.

5. A speaker according to claim 1, wherein the diaphragm further comprises an adhesive layer disposed between the primary and secondary planar discs, and a thickness of the primary planar disc is larger than an aggregate thickness of the secondary planar disc and the adhesive layer.

6. A speaker according to claim 1, wherein the primary and secondary planar discs are made of a resin film.

7. A speaker according to claim 1, wherein a cover member which has its outer circumference connected to the frame is disposed above the diaphragm.

8. A speaker according to claim 7, wherein the cover member is formed integrally with the frame.
